(19) United States
(12) Patent Application Publication
(10) Pub. No.: US 2024/0152906 A1
(43) Pub. Date: May 9, 2024

(54) Systems and Methods for Minting Digital Assets Associated With User Achievements in a Distributed Network

(71) Applicant: STATE FARM MUTUAL AUTOMOBILE INSURANCE COMPANY, Bloomington, IL (US)

(72) Inventors: Brian Fields, Phoenix, AZ (US); Ellakate LeFebre, Mesa, AZ (US); Anthony Welcome, Mesa, AZ (US); Steve Amancha, Tempe, AZ (US); Jose Ivan Gutierrez, Laveen, AZ (US)

(21) Appl. No.: 18/238,339

(22) Filed: Aug. 25, 2023

Related U.S. Application Data
(60) Provisional application No. 63/423,263, filed on Nov. 7, 2022.

(51) Int. Cl. G06Q 20/36

(52) U.S. Cl. CPC G06Q 20/3672; G06Q 2220/00

(57) ABSTRACT

Techniques are described herein for minting digital assets associated with user achievements in a distributed network. An exemplary system includes one or more processors; and a non-transitory computer-readable medium coupled to the one or more processors and storing instructions thereon. The instructions, when executed by the one or more processors, cause the one or more processors to: (1) receive an update from a platform application on a user computing device, the update including (i) an association indication between a first entity of the user computing device and a second entity and (ii) an achievement of the first entity; (2) generate a transaction based upon the update, the transaction including a digital asset associated with the update; (3) record the transaction in a distributed ledger; and (4) responsive to recording the transaction in the distributed ledger, transmit a notification to the user computing device indicating the digital asset.

### CROSS-REFERENCE TO RELATED APPLICATIONS

This application claims priority to U.S. Provisional Patent Application No. 63/423,263, entitled “Systems and Methods for Minting Digital Assets Associated With User Achievements in a Distributed Network,” filed on Nov. 7, 2022, the disclosure of which is hereby incorporated herein by reference.

### TECHNICAL FIELD

The present disclosure relates generally to systems and methods to mint digital assets in a distributed ledger. In particular, a system of the present disclosure provides an infrastructure including a distributed ledger for minting digital assets associated with user achievements in a distributed network.

### BACKGROUND

Even in today's highly digitized and automated world, a high percentage of activities surrounding the identification, recordation, ownership, transfer, and management of property may be manual, inefficient, inaccurate, non-secure, and subject to costly errors, fraud, abuse, corruption, and theft. For example, many types of property and associated documents, such as titles and deeds, may be recorded in a variety of registries such as land registries, registrars, registers of deeds, departments and bureaus of motor vehicle registries, vessel registries, aircraft registries, patent and trademark offices, and so forth. These registries may additionally vary by jurisdiction including by country, state, province, district, sub-district, county, parish, and local municipalities (e.g., cities, villages, settlements, communes and the like).

There are many possible mistakes and errors related to these legacy registries that may result in a variety of problems. For example, if defects are present and uncleared at the time of closing on a sale of an asset, the sale may be invalidated, and the buyer may even sue the seller. There may be many types of defects, most of which are recorded defects introduced by human errors and which are herein referred to as Human Induced Defects (HIDs) which often may come in the form of mistyped names, transcription errors from paper-based documents and other non-automated sources, and missing property descriptions or incorrect legal descriptions. Defects for insurance policies maintained on legacy systems may include incorrect insured information (e.g., misspelled name, address), incorrect coverage amount, incorrect deductibles/premiums, incorrect beneficiary, incorrect policy terms, transcription errors, and the like. Such defects may block the issuance of a policy and/or payouts from such policies, and non-recorded defects may impact title/claims to a property or benefits covered/offered under such policies.

These issues may be further exasperated in circumstances where entities attempt to provide users with incentives or other rewards in exchange for certain behaviors or actions. For example, an insurance entity may offer incentives for owners of life insurance policies issued by the insurance entity. Users may need to prove that they own an active life insurance policy and that they have successfully performed the behaviors or actions specified by the insurance entity (e.g., receive yearly health screenings from a physician) in order to obtain a reduced premium. However, conventional systems that suffer from inaccurate processes to record information for such life insurance policies may similarly fail to accurately obtain, update, and/or otherwise integrate such behavior or action information for the user to obtain the corresponding benefits.

Taken together, these disadvantages of conventional systems create a substantial need for distributed ledger technology for minting digital assets associated with user achievements in a distributed network.

### SUMMARY

The present disclosure relates to, inter alia, Distributed Ledger Technology (DLT) which enables digital systems to record the characteristics of assets (e.g., vehicles, insurance policies, etc.), such as by minting tokens (also referenced herein as “digital assets”) that may enable users to achieve benefits through achievement and/or to sell the digital assets on a digital asset platform. These digital assets may generally correspond to and/or otherwise represent transactions and operations performed on, or in association with, the assets. As a result of the DLT, each of these digital assets and their associated details may be recorded in multiple places at the same time.

Unlike traditional databases, distributed ledgers have no central data store. The present disclosure relates to public ledgers, which are databases that are consensually shared and synchronized across multiple sites, institutions, or geographies. Such public ledgers are generally accessible by multiple people and systems, allow transactions to have public “witnesses,” and participants at each node of the network can access the recordings shared across that network and can own identical copies of it. Any changes or additions made to the public ledger are reflected and copied to all participants. Such public ledgers are generally built in a standardized manner, such that two relatively independent public ledgers may communicate through cross-ledger interoperability. This cross-ledger implementation may be mainly represented by asset swaps and asset transfers, and through such an implementation, the limitations of a single ledger may be avoided.

Of course, the systems and methods of the present disclosure may additionally, or alternatively, include private ledgers, federated ledgers, and/or any other suitable types or combinations of ledgers. For example, the present disclosure may include private ledgers, which are permissioned distributed ledger systems where a single authority or organization has write-access to the network and control over read permissions can be public or restricted if a public readability feature is included in the private ledger. Similarly, the present disclosure may include federated ledgers, which are hybrid public/private ledgers that are similar to private ledgers, but which remove the sole organization influence from the network and enable multiple entities to use the network for their benefit as a hub where the multiple organizations can simultaneously exchange information and work, thereby enabling participants to “fast forward” any kind of work requiring multiple entities to participate or approve transactions.

Furthermore, the present disclosure may relate to smart contracts, which are computerized transaction protocols that execute terms of a contract and can be self-executing. In effect, a smart contract has a conditional or an “if” component (i.e., the “left hand side” of a rule), and also has an executable or “then” component (i.e., called the “right hand side” of a rule), with the difference being that a smart contract “watches” a distributed ledger for its conditions to be met at which point it “fires” or executes and immutably records its actions (contract) on the distributed ledger.

Techniques, systems, apparatuses, components, devices, and methods are disclosed for utilizing a distributed ledger, or blockchain, for minting digital assets in response to user achievements and allowing the users to access a digital asset platform to interact with other users by selling, buying, auctioning, and/or otherwise transacting with the digital assets. In an asset recordation system utilizing such a distributed ledger, the distributed ledger may be maintained by nodes. The distributed ledger architecture may include a public distributed ledger which is accessible by multiple people and systems, is permissionless, and allows transactions to have public “witnesses.” Participants at each node of the network can access the recordings shared across that network and can own identical copies of it. Any changes or additions made to the public distributed ledger may be reflected and copied to all participants. The public distributed ledger may also obtain identification information for assets, which may uniquely identify an asset, and may be static and immutable in the public distributed ledger.

In certain embodiments, the distributed ledger architecture may also include a private distributed ledger where a single authority or organization has write-access to the network, and control over read permissions can be public or restricted if a public readability feature is included in the private ledger. If such read permissions are restricted, a user attempting to view the private ledger may need to enter a username (or user name) and password for authentication. For example, the private distributed ledger may obtain transaction-related documents for assets, such as contracts, title documents, deeds, mortgages, liens, lease documents, etc. The transaction-related documents may be dynamic and more memory intensive than the identification information and the ownership information. Moreover, the transaction-related documents may be more sensitive and private than the identification information and ownership information. Accordingly, the transaction-related documents may be managed by a single authority or organization rather than a public distributed ledger that may be accessed by any computing device.

In some embodiments, the distributed ledger architecture may also include a federated distributed ledger layer which requires nodes to receive permission to append data to the federated distributed ledger. Control over read permissions can be public or restricted if a public readability feature is included in the federated ledger. If such read permissions are restricted, a user attempting to view the federated ledger may need to enter a username (or user name) and password for authentication. The federated distributed ledger may obtain ownership information for properties, such as transfers of ownership of a property from one owner to another, the dates of the transfers, the sale prices of the transfers, encumbrances on the property, etc. The ownership information may be dynamic and more memory intensive than the identification information. Moreover, the ownership information may be more sensitive and private than the identification information. Accordingly, the ownership information is managed by the federated distributed ledger layer rather than a public distributed ledger layer that can be accessed by any computing device.

Regardless, in instances where multiple distributed ledgers communicate to accurately record asset transactions, these multiple distributed ledgers may reference each other so that a user may obtain asset information for the same asset from each ledger. For example, a user may mint digital assets by recording transactions in the distributed ledger that include a representation of an asset (e.g., another digital asset, a virtual asset, and/or a real-world asset). These digital assets may be or include a non-fungible token (NFT) representing an asset on a first public ledger, where the NFT includes identification and ownership information for the asset. The NFT may be wrapped in wrapped NFTs on a second public distributed ledger, such that the first and second ledgers may reference each other through the NFT and wrapped NFTs referring to the NFT. In other embodiments, the multiple distributed ledgers may reference each other using any suitable combination of identifiers and/or cross-chain tools, such as asset identifiers, creator identifiers, chain identifiers, digital certificate of authenticity identifiers, owner identifiers, transaction identifiers, user identifiers, RDF identifiers, location identifiers, etc.

As mentioned, the systems and methods of the present disclosure may also include minting digital assets in response to user achievements. For example, a user may track certain activities that the user performs via a user computing device, and the user computing device may transmit updates to the user's performance to a computing node. The computing node may interpret the updates to the user's performance, and may generate and record transactions reflecting the updates in the distributed ledger. These transactions may mint and/or otherwise update digital assets associated with the updates of the user's performance/achievements. The computing node may then transmit a notification to the user computing device indicating the digital asset associated with the update. These achievements may include various behaviors, such as (i) an exercise value, (ii) an eating value, (iii) a sleep value, (iv) a driving value, (v) a total investment value, and/or (vi) a policy length value.

In certain embodiments, the digital asset may have a corresponding value, and the user may be able to redeem the digital asset in various manners based on the corresponding value. For example, the digital asset may have a corresponding value that may be redeemed and/or otherwise obtained through (i) a discount corresponding to an association indicated by the association indication between the first entity and the second entity, (ii) a real-world currency value, (iii) a virtual currency value, and/or (iv) a discount corresponding to a third entity, among others.

Additionally, the systems and methods of the present disclosure may also include a digital asset platform that enables users to view and/or transact with other entities/users and corresponding digital assets. For example, when the user receives a digital asset as a result of an achievement, the user may decide to upload the digital asset to the digital asset platform. Once on the digital asset platform, the user may sell or auction the digital asset to other entities/users that are connected to the digital asset platform (e.g., via a platform application). In certain embodiments, an entity/user that manages and/or otherwise has administrative permissions regarding the digital asset platform may mint digital assets on the distributed ledger and post the digital assets directly to the digital asset platform for auction/sale by other entities/users.

Further, the systems and methods of the present disclosure include users interacting with other users via digital tokens. For example, online digital identities, as implemented by use of digital tokens on a blockchain, may provide a single source of user authentication for a given user and reduce digital waste across networks. Such digital identities may be used in a variety of ways to identify respective users.

Namely, digital tokens may be associated with users where such digital tokens may be used to provide respective digital identities to authenticate a select group of users (e.g., fans) for the purpose transacting with, or associating users with, people (e.g., musicians) or entities (e.g., sports teams). Such digital tokens may provide access or privileges in either real-world or virtual environments, such as sporting events, concerts, in videogames, or in the Metaverse. In various embodiments, a user's digital token(s), and/or related public and private keys, may be used to identify and/or authenticate a user and server as a single source of authenticity and identification to a variety of entities, persons, and related systems.

One exemplary embodiment of the techniques of this disclosure is a computer system for minting digital assets associated with user achievements in a distributed network. The computer system may include one or more local or remote processors, transceivers, sensors, servers, memory units, mobile devices, wearables, smart glasses, augmented reality glasses, virtual reality headsets, or other electronic or electrical components. In one instance, the system may include one or more processors; and a non-transitory computer-readable medium coupled to the one or more processors and storing instructions thereon. When executed by the one or more processors, the instructions cause the one or more processors to: (1) receive an update from a platform application on a user computing device, the update including (i) an association indication between a first entity of the user computing device and a second entity and/or (ii) an achievement of the first entity; (2) generate a transaction based upon the update, the transaction including a digital asset associated with the update; (3) record the transaction in a distributed ledger; and/or (4) responsive to recording the transaction in the distributed ledger, transmit a notification to the user computing device indicating the digital asset associated with the update. The system may be configured to have additional, less, or alternate functionality, including that discussed elsewhere herein.

Another exemplary embodiment of the techniques of this disclosure is a computer-implemented method for minting digital assets associated with user achievements in a distributed network. The computer-implemented method may be implemented via one or more local or remote processors, transceivers, sensors, servers, memory units, mobile devices, wearables, smart glasses, augmented reality glasses, virtual reality headsets, or other electronic or electrical components. In one instance, the method includes (1) receiving, from a platform application on a user computing device, an update including (i) an association indication between a first entity of the user computing device and a second entity and/or (ii) an achievement of the first entity; (2) generating, by one or more processors, a transaction based upon the update, the transaction including a digital asset associated with the update; (3) recording, by the one or more processors, the transaction in a distributed ledger; and/or (4) responsive to recording the transaction in the distributed ledger, transmitting, by the one or more processors, a notification to the user computing device indicating the digital asset associated with the update. The method may include additional, less, or alternate actions, including those discussed elsewhere herein.

Yet another exemplary embodiment of the techniques of this disclosure is a tangible, non-transitory computer-readable medium storing instructions for minting digital assets associated with user achievements in a distributed network. When executed by one or more processors of a computing device, the instructions may cause the computing device to: (1) receive an update from a platform application on a user computing device, the update including (i) an association indication between a first entity of the user computing device and a second entity and/or (ii) an achievement of the first entity; (2) generate a transaction based upon the update, the transaction including a digital asset associated with the update; (3) record the transaction in a distributed ledger; and/or (4) responsive to recording the transaction in the distributed ledger, transmit a notification to the user computing device indicating the digital asset associated with the update. The instructions may direct additional, less, or alternate functionality, including that discussed elsewhere herein.

Therefore, in accordance with the above, and with the disclosure herein, the present disclosure includes improvements in computer functionality or in improvements to other technologies at least because the present disclosure describes that, e.g., asset transaction and recording systems, may be improved or enhanced with the disclosed systems and methods for minting digital assets associated with user achievements in a distributed network. That is, the present disclosure describes improvements in the functioning of asset transaction and recording systems itself or “any other technology or technical field” (e.g., asset transfer, asset updating, and asset recordation field) because the disclosed systems and methods improve and enhance the operation of asset transaction, updating, and recording systems by introducing digital asset (e.g., NFT) minting, auctioning, and redemption through achievements of users using distributed ledgers in a manner that is unachievable using conventional systems and methods. This improves over the prior art at least because such conventional systems were error-prone, as they lack the ability for minting, auctioning, and redeeming such digital assets based upon user achievements.

Moreover, the present disclosure includes effecting a transformation or reduction of a particular article to a different state or thing, e.g., transforming or reducing the generation and/or recordation of asset transaction records and digital assets from a non-optimal or error state to an optimal state.

Still further, the present disclosure includes specific features other than what is well-understood, routine, conventional activity in the field, or adding unconventional steps that demonstrate, in various embodiments, particular useful applications, e.g., (1) receiving, from a platform application on a user computing device, an update including (i) an association indication between a first entity of the user computing device and a second entity and/or (ii) an achievement of the first entity; (2) generating, by one or more processors, a transaction based upon the update, the transaction including a digital asset associated with the update; and/or (3) recording, by the one or more processors, the transaction in a distributed ledger.

### BRIEF DESCRIPTION OF THE DRAWINGS

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

The figures described below depict various aspects of the applications, methods, and systems disclosed herein. It should be understood that each figure depicts an embodiment of a particular aspect of the disclosed applications, systems and methods, and that each of the figures is intended to accord with a possible embodiment thereof. Furthermore, wherever possible, the following description refers to the reference numerals included in the following figures, in which features depicted in multiple figures are designated with consistent reference numerals.

FIG. 1 is a block diagram illustrating an exemplary computing system in accordance with an illustrative embodiment, in accordance with various embodiments herein.

FIG. 2A is an exemplary distributed ledger system for recording transactions and executing smart contracts in an asset recordation system, in accordance with various embodiments herein.

FIG. 2B illustrates exemplary components of a network node on a distributed ledger network in an asset recordation system, in accordance with various embodiments herein.

FIG. 3 illustrates exemplary validating network nodes and an exemplary transaction flow on a distributed ledger network in an asset recordation system, in accordance with various embodiments herein.

FIG. 4 illustrates an exemplary transaction recording identification information for an asset in a public distributed ledger, in accordance with various embodiments herein.

FIG. 5 illustrates exemplary digital asset minting transactions in response to receiving updates from a platform application of a user computing device, in accordance with various embodiments herein.

FIG. 6 depicts an exemplary digital asset platform communicating with multiple user computing devices executing a platform application, in accordance with various embodiments herein.

FIG. 7 is a block diagram of an exemplary computer-implemented method for minting digital assets associated with user achievements in a distributed network, in accordance with various embodiments herein.

### DETAILED DESCRIPTION

Generally speaking, a distributed ledger is a storage mechanism for data, events, transactions, etc. that is maintained by several participants. More specifically, a distributed ledger is a way of achieving a distributed consensus on the validity or invalidity of information recorded in the distributed ledger. In other words, the distributed ledger provides a decentralized trust to participants and observers. As opposed to relying on a central authority, a distributed ledger is a decentralized database in which a transactional record of changes to the ledger is maintained and validated by each node of a peer-to-peer network. One type of distributed ledger, a blockchain, is comprised of groupings of transactions organized together into a “block,” and ordered sequentially. While the distributed ledgers discussed herein are referred to in the context of a blockchain, this is merely one example of a distributed ledger. Distributed ledgers may also include a tangle, a block lattice, or other directed acyclic graph (DAG). In any event, nodes may join and leave the blockchain network over time and may obtain blocks from peer nodes that were propagated while the node was gone. Nodes may maintain addresses of other nodes and exchange addresses of known nodes with one another to facilitate the propagation of new information across the network in a decentralized, peer-to-peer manner.

The nodes that share the ledger form what is referred to herein as the distributed ledger network. The nodes in the distributed ledger network validate changes to the blockchain (e.g., when a new transaction and/or block is created) according to a set of consensus rules. The consensus rules depend on the information being tracked by the blockchain and may include rules regarding the chain itself. For example, a consensus rule may include that the originator of a change supply a proof-of-identity such that only approved entities may originate changes to the chain. A consensus rule may require that blocks and transactions adhere to format requirements and supply certain meta information regarding the change (e.g., blocks must be below a size limit, transactions must include a number of fields, etc.). Consensus rules may include a mechanism to determine the order in which new blocks are added to the chain (e.g., through a proof-of-work system, proof-of-stake, etc.).

Additions to the blockchain that satisfy the consensus rules are propagated from nodes that have validated the addition to other nodes recognized by the validating node. If all of the nodes that receive a change to the blockchain validate the new block, then the distributed ledger reflects the new change as stored on all nodes, and it may be said that distributed consensus has been reached with respect to the new block and the information contained therein. Any change that does not satisfy the consensus rule is disregarded by validating nodes that receive the change and the change is not propagated to other nodes. Accordingly, unlike a traditional system which uses a central authority, a single party cannot unilaterally alter the distributed ledger unless the single party can do so in a way that satisfies the consensus rules. The inability to modify past transactions leads to blockchains being generally described as trusted, secure, and immutable.

The validation activities of nodes applying consensus rules on a blockchain network may take various forms. In one embodiment, the blockchain may be viewed as a shared spreadsheet that tracks data such as the ownership of assets. In another embodiment, the validating nodes execute code contained in “smart contracts” and distributed consensus is expressed as the network nodes agreeing on the output of the executed code.

As previously mentioned, a smart contract is a computer protocol that enables the automatic execution and/or enforcement of an agreement between different parties. In particular, the smart contract may be computer code that is located at a particular address on the blockchain. In some cases, the smart contract may run automatically in response to a participant in the blockchain sending funds (e.g., a cryptocurrency such as bitcoin, ether, or other digital/virtual currency) to the address where the smart contract is stored. Additionally, smart contracts may maintain a balance of the amount of funds that are stored at their address. In some scenarios when this balance reaches zero the smart contract may no longer be operational.

The smart contract may include one or more trigger conditions, that, when satisfied, correspond to one or more actions. For some smart contracts, the action(s) performed may be determined based upon one or more decision conditions. In some instances, data streams may be routed to the smart contract so that the smart contract may detect that a trigger condition has occurred and/or analyze a decision condition.

Blockchains may be deployed in a public, decentralized, and permissionless manner meaning that any party may view the distributed ledger, submit new information to be added to the ledger, or join the network as a validating node. Other blockchains are private (e.g., permissioned ledgers) that keep chain data private among a group of entities authorized to participate in the blockchain network. Other blockchain implementations may be both permissioned and permissionless whereby participants may need to be validated, but only the information that participants in the network wish to be public is made public.

In some embodiments, a distributed ledger includes multiple blockchains such as a main blockchain and several side chains operating independently of the main blockchain. The side chains then interact with the main blockchain to provide some of the transaction data from the side chains to the main blockchain. In this manner, the side chains can be permissioned or private while the main blockchain is public or available to a larger number of entities than the side chains. Non-sensitive information from the side chains may be shared on the main blockchain. Also in some embodiments, a distributed ledger includes multiple layers or separate blockchains executing in parallel that are maintained by the same validating nodes. Some of the transaction data from the blockchain for the first layer may be provided to the blockchain for the second layer or vice versa.

In one example, a distributed ledger in an asset recordation system may be maintained by validating nodes which transmit data to remote systems using one or more public and/or private networks, such as a private enterprise network, the Internet, a cellular router, a backhaul Internet or other type backhaul connection. The validating nodes receive transactions broadcasted to the distributed ledger network by for example, user devices. The nodes then validate the broadcasted transactions. In another example, the validating nodes execute code contained in smart contracts and other devices act as “evidence oracles” which provide evidence related to title transfers, maintenance updates, etc. to the blockchain. Oracles may be systems, devices, or entities that connect a deterministic system with a non-deterministic system or data source.

Regardless, the systems and methods of the present disclosure may rely on and/or otherwise include this distributed ledger technology to enable vehicle owners/sellers to track transactions related to a real-world vehicle, such as by minting digital assets in response to a user achievement as part of a distributed network. As a result, a user may maintain all transactions related to assets owned by the user on the blockchain as a trusted, secure, and/or immutable form of record-keeping/documentation. For example, such a user may record mechanic repairs/maintenance, buying/selling vehicles, vehicle recalls, carbon tax credits received by the user as a result of owning/driving the vehicle, life insurance policy updates/achievements, property insurance policy updates/achievements, and/or any other transactions involving the user's assets.

As another example, a service provider (e.g., insurance provider) may post transactions to the distributed ledger that include a digital asset representing a recent achievement of the user corresponding to a life insurance policy owned by the user. Posting the transaction with the digital asset to the distributed ledger for a first time may represent the service provider minting the digital asset on the distributed ledger. This minted digital asset may then be transmitted to the user via a notification, as well as optionally posted to a digital asset platform for sale, auction, and/or otherwise redemption as a form of compensation for the user. The status of the digital asset may change over time as the user continues to reach different achievements, the value of an underlying asset changes (e.g., an insurance policy, investment account), the status of the underlying asset changes (e.g., active/inactive insurance policy), and/or any other suitable changes take place.

In the following description, for the purposes of explanation, specific details are set forth in order to provide a thorough understanding of various embodiments and examples. Various embodiments may be practiced without these specific details. The figures and description are not intended to be restrictive.

### Exemplary Computing Systems and Components for Executing a Distributed Ledger Network

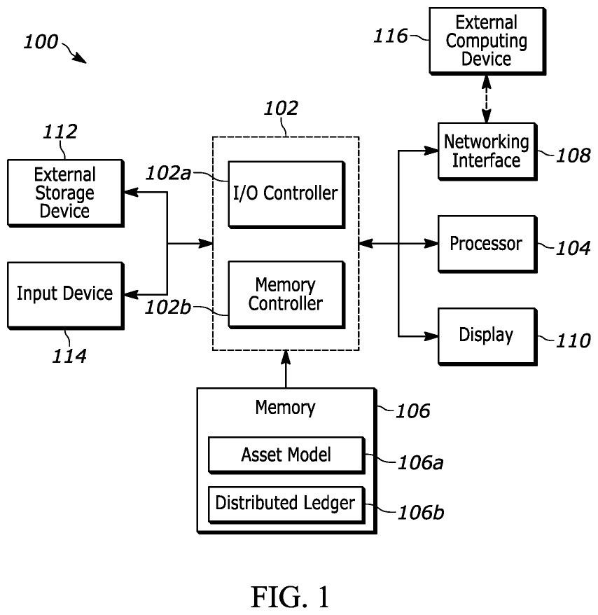

FIG. 1 is a block diagram illustrating an exemplary computing system 100 in accordance with an illustrative embodiment, in accordance with various embodiments herein. In other examples, fewer, additional, or different components may be present. The computing system 100 may be any suitable computing machine such as a tablet, smart phone, mobile device, laptop computer, desktop computer, server, remote client device, gaming device, smart television device, wearable computer, or any combination thereof. The computing system 100 may include at least one processor 104 coupled to a central hub 102. The central hub 102 may include a memory controller 102b and an input/output (I/O) controller 102a. Each of a memory 106, a networking interface 108, a display 110, an external storage device 112, and an input device 114 may be coupled to the central hub 102. In certain instances, the memory 106 may be coupled specifically to the memory controller 102b; and the external storage device 112, the input device 114, networking interface 108, and the display 110 may be coupled to the I/O controller 102a. Other examples of the computing system 100 may be characterized by different architectures.

Broadly speaking, the computing system 100 may represent a node of a distributed ledger system. This distributed ledger system may include a public ledger, a private ledger, a federated ledger, and/or any other suitable ledgers or layers and combinations thereof. For example, the computing system 100 may include an Internet of Things (IoT)/device layer (not shown) stored in memory 106. The IoT layer may be a system of interrelated computing devices, mechanical and digital machines, objects, animals or people that are provided with unique identifiers (UIDs) and have the ability to transfer data over a network (via networking interface 108) without requiring human-to-human or human-to-computer interaction.

Users (e.g., buyers, sellers, maintenance professionals, appraisers, etc.) may interact through the computing system 100 by recording asset transactions of real world assets (e.g., vehicles, insurance policies, investment accounts, etc.) via the distributed ledger 106b. Additionally, other applications (e.g., the platform application 106a), application programming interfaces (APIs), algorithms/models, and/or intelligent user interfaces may also be stored in the memory 106 and utilized with the distributed ledger 106b to facilitate the recordation and/or transfer of assets.

The assets may be real world assets, virtual assets, intellectual assets (e.g., patents, trademarks, copyrights, etc.), and/or any suitable type of assets or combinations thereof. The asset information included in records of the distributed ledger 106b and/or otherwise utilized by the processor 104 when updating the distributed ledger 106b may include identification information for the asset, such as a name of the asset, a location of the asset, a unique identification number for the asset, any digital assets (e.g., NFTs) associated with the asset, etc. The asset information may also include ownership information for the asset, such as a name of the person or organization that currently owns the asset, an address of the current owner, a phone number of the current owner, and/or any other suitable identification information for the current owner. The ownership information may also include identification information for each of the previous owners of the asset, dates on which the asset was transferred, etc. Still further, the asset information may include title information for the asset, encumbrances on the asset, documents related to the title and transfers of ownership, etc., such as deeds, contracts related to the sale of the asset, mortgages and/or liens on the asset, leases on the asset, etc.

Accordingly, the distributed ledger 106b may generally include information corresponding to assets (e.g., vehicles, insurance policies, investment accounts). As an example where the assets are insurance policies, the distributed ledger 106b may include policy information, such as coverage amounts, coverage limits, deductibles, premiums, beneficiaries, policy terms, and/or an NFT/certificate representative of any of this information or combinations thereof. The distributed ledger 106b may further include ownership information for the insurance policies, such as the name, address, phone number, unique identification number, etc., of a person or entity that owns the insurance policy. Moreover, the distributed ledger 106b may include transaction-related documents, such as insurance documents signed by each party, etc. In certain embodiments, the processors 104 may obtain the policy information, the ownership information, and/or transaction-related documents for recordation in the distributed ledger 106b from an insurance provider, a legacy recording system, and/or other data sources (e.g., via the networking interface 108).

In any event, the computing system 100 may also communicate with external computing devices 116 (also referenced herein as “nodes”) to perform the validation/consensus process required to update/change entries included in the distributed ledger 106b. In certain embodiments, these external computing devices 116 may also be or include integration devices and/or legacy systems that store and/or otherwise include identification information, ownership information, transaction-related documents and/or any other suitable information for assets that is relevant to the entries in the distributed ledger 106b. For example, the integration devices of the external computing devices 116 may be or include middleware used to transform, route, clone, and/or translate data between multiple computing systems 100.

When the computing system 100 receives and/or otherwise has the necessary asset information, and the processor 104 successfully executes the validation/consensus calculations/process, then the processor 104 may record any suitable asset information into the distributed ledger 106b. As part of this recordation in the distributed ledger 106b, the processor 104 may mint a token (e.g., an NFT) representing the asset, where the token acts as a digital deed or certificate of ownership of the asset. Additionally, or alternatively, the processor 104 may mint a digital asset representing a product or service associated with the asset.

In addition to minting an NFT representing the asset and/or a product/service associated with the asset, the processor 104 may communicate with a third-party certificate authority (e.g., included as part of an external computing device 116) to generate a certificate of authenticity for the owner of the asset, and/or the processor 104 may mint and/or otherwise receive a verifiable credential from an issuer (e.g., insurance provider) corresponding to the asset. The received verifiable credential and/or certificate may be stored in a user's digital wallet, such that the verifiable credential and/or certificate may be accessible only by the user and other users/entities to which the user shares the verifiable credential and/or certificate.

Such a verifiable credential may be or include a hash value representative of a transaction that occurred corresponding to the asset. Therefore, if the asset is a digital/virtual asset, the verifiable credential may represent authenticated transactions corresponding to the asset without storing the asset directly in the distributed ledger 106b. The certificate and/or verifiable credential may include a description of the asset, such as a name of the asset, a location of the asset, a unique identification number for the asset, etc.; and identification information for the owner of the asset, such as a name of the person or organization that currently owns the asset, an address of the current owner, a phone number of the current owner, etc. The certificate and/or verifiable credential may also include information corresponding to the asset that is recorded in and/or otherwise associated with the distributed ledger 106b, such as a reference to the NFT, certificate, and/or verifiable credential representing the asset (e.g., a token ID and/or smart contract address for the NFT) and/or product/service associated with the asset.

In some embodiments, the memory 106 may additionally include instructions that enable the processor 104 to recognize and classify digital certificates of authenticity and/or verifiable credentials as either from a valid, “accredited” authenticator (e.g., Verisart for physical art, PSA for sports trading cards, etc.) and to reject a digital certificate of authenticity and/or verifiable credential if it is not from a valid “accredited” authenticator. For example, the instructions stored in memory 106 may cause the processor 104 to identify acceptable, valid patterns in certificates of authenticity and/or verifiable credentials from the accredited providers.

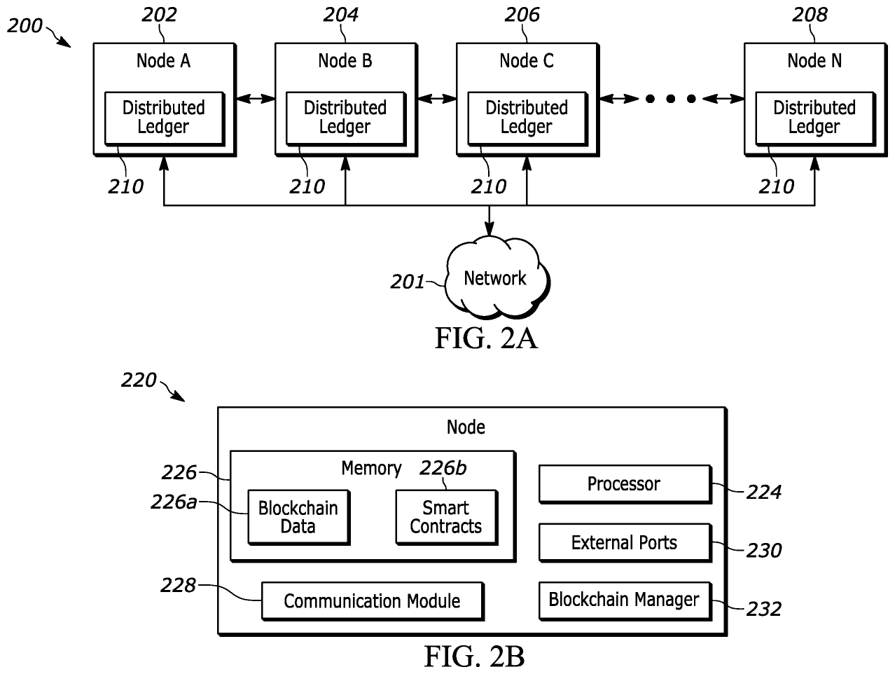

Regardless, the operations described herein and with respect to FIGS. 2-7 may be performed partially or wholly on, or otherwise using, the processor 104. For example, the processor 104 can execute one or more operations for generating, recording, auctioning, selling, redeeming, and/or otherwise transacting with digital assets via a platform application 106a. In some examples, the platform application 106a may be stored on each computing device that is a node of the distributed ledger network, and/or may be stored on each computing device that is connected to at least one node of the distributed ledger network.

More generally, the processor 104 can execute instructions stored in the memory 106 to perform the operations. The processor 104 can include one processing device or multiple processing devices or cores. For example, the processor 104 may be or include one or more central processing units (CPUs), one or more graphics processing units (GPUs), one or more Field-Programmable Gate Arrays (FPGAs), one or more application-specific integrated circuits (ASICs), one or more microprocessors, etc.

Further, the processor(s) 104 may be connected to the memory 106 via a computer bus responsible for transmitting electronic data, data packets, or otherwise electronic signals to and from the processor(s) 104 and memory 106 in order to implement or perform the machine readable instructions, methods, processes, elements or limitations, as illustrated, depicted, or described for the various flowcharts, illustrations, diagrams, figures, and/or other disclosure herein.

The processor(s) 104 may interface with the memory 106 via the computer bus to execute an operating system (OS). The processor(s) 104 may also interface with the memory 106 via the computer bus to create, read, update, delete, or otherwise access or interact with the data stored in the memory 106 and/or the external storage device 112 (e.g., a relational database, such as Oracle, DB2, MySQL, or a NoSQL based database, such as MongoDB). The data stored in the memories 106 and/or the external storage device 112 may include all or part of any of the data or information described herein, including, for example, training data and/or asset data (e.g., insurance policy data, investment account data, vehicle data) or other information of the user or a corresponding asset. The memory 106 may include one or more persistent memories (e.g., a hard drive and/or solid state memory) and may store one or more applications (e.g., platform application 106a), modules, and/or models.

In general, a computer program or computer based product, application, or code (e.g., the model(s), such as AI models, or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the processor 104 (e.g., working in connection with the respective operating system in the memory 106) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang, Python, C, C++, C #, Objective-C, Java, Scala, ActionScript, JavaScript, HTML, CSS, XML, etc.).

More generally, the memory 106 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. The memory 106 may store an operating system (OS) (e.g., Microsoft Windows, Linux, Unix, etc.) capable of facilitating the functionalities, apps, methods, or other software as discussed herein. The memory 106 may also store a platform application 106a, which may provide access to a digital asset platform (not shown) where a user may engage with other entities/users in the sale, auction, purchase, redemption, and/or other transactions related to digital assets, as described herein. Additionally, or alternatively, the platform application 106a may also be stored in the external storage device 112, which is accessible or otherwise communicatively coupled to the central hub 102.

The memory 106 may also store machine readable instructions, including any of one or more application(s), one or more software component(s), and/or one or more application programming interfaces (APIs), which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein. For example, at least some of the applications, software components, or APIs may be, include, otherwise be part of, an asset or transactional component, such as the platform application 106a, where each may be configured to facilitate their various functionalities discussed herein. It should be appreciated that one or more other applications may be envisioned and that are executed by the processor 104.

In some examples, the memory 106 can include computer program instructions for executing or applying the platform application 106a. For example, the instructions can include the platform application 106a that is executable by the processor 104 for causing the processor 104 to access a digital asset platform where a user may engage with other entities/users in the sale, auction, purchase, redemption, and/or other transactions related to digital assets, as described herein. In certain embodiments, the platform application 106a may include a platform model (not shown), which the processor 104 may execute to generate evaluations/estimations or assessments of the potential list price of the digital asset on a digital asset platform. Such evaluations/estimations or assessments of the potential list price of the digital asset may include quantitative values, such as numeric scores or other types of quantitative information indicating whether the potential list price is within a threshold range of a predicted sale price and/or otherwise redemption value for the digital asset. For example, the platform model may output quantitative information, such as a percentage score or a percentile score indicating a likelihood that the digital asset will sell for the potential list price on the digital asset platform.

More specifically, in certain embodiments, the processor 104 may utilize one or more machine learning (ML) techniques to train the platform model as a ML model. The platform model may be trained using a training dataset that includes a plurality of digital asset data, such as prior listing values for digital assets associated with prior assets, prior sale values for such digital assets, and/or any other suitable data and combinations thereof. The platform model may use the training dataset to output, for each digital asset for which the platform model receives digital asset data as an input, a potential listing value, a potential sale value, and/or other suitable values or combinations thereof.

Generally speaking, ML techniques have been developed that allow parametric or nonparametric statistical analysis of large quantities of data. Such ML techniques may be used to automatically identify relevant variables (i.e., variables having statistical significance or a sufficient degree of explanatory power) from data sets. This may include identifying relevant variables or estimating the effect of such variables that indicate actual observations in the data set. This may also include identifying latent variables not directly observed in the data, viz. variables inferred from the observed data points. More specifically, a processor or a processing element may be trained using supervised or unsupervised ML.

In supervised machine learning, a machine learning program operating on a server, computing device, or otherwise processors, may be provided with example inputs (e.g., “features”) and their associated, or observed, outputs (e.g., “labels”) in order for the machine learning program or algorithm to determine or discover rules, relationships, patterns, or otherwise machine learning “models” that map such inputs (e.g., “features”) to the outputs (e.g., labels), for example, by determining and/or assigning weights or other metrics to the model across its various feature categories. Such rules, relationships, or otherwise models may then be provided subsequent inputs in order for the model, executing on a server, computing device, or otherwise processors as described herein, to predict or classify, based upon the discovered rules, relationships, or model, an expected output, score, or value.

In unsupervised machine learning, the server, computing device, or otherwise processors, may be required to find its own structure in unlabeled example inputs, where, for example multiple training iterations are executed by the server, computing device, or otherwise processors to train multiple generations of models until a satisfactory model, e.g., a model that provides sufficient prediction accuracy when given test level or production level data or inputs, is generated.

Exemplary ML programs/algorithms that may be utilized by the processor 104 to train the platform model may include, without limitation: neural networks (NN) (e.g., convolutional neural networks (CNN), deep learning neural networks (DNN), combined learning module or program), linear regression, logistic regression, decision trees, support vector machines (SVM), naïve Bayes algorithms, k-nearest neighbor (KNN) algorithms, random forest algorithms, gradient boosting algorithms, Bayesian program learning (BPL), voice recognition and synthesis algorithms, image or object recognition, optical character recognition (OCR), natural language understanding (NLU), and/or other ML programs/algorithms either individually or in combination.

After training, ML programs (or information generated by such ML programs) may be used to evaluate additional data. Such data may be and/or may be related to asset data of particular assets that was not included in the training dataset. The trained ML programs (or programs utilizing models, parameters, or other data produced through the training process) may accordingly be used for determining, assessing, analyzing, predicting, estimating, evaluating, or otherwise processing new data not included in the training dataset. Such trained ML programs may, therefore, be used to perform part or all of the analytical functions of the methods described elsewhere herein.

It is to be understood that supervised ML and/or unsupervised ML may also comprise retraining, relearning, or otherwise updating models with new, or different, information, which may include information received, ingested, generated, or otherwise used over time. The disclosures herein may use one or more of such supervised and/or unsupervised ML techniques. Further, it should be appreciated that, as previously mentioned, the platform model may be used to output potential listing values, potential sale values, and/or other suitable values or combinations thereof, using artificial intelligence (e.g., a ML model of the platform model) or, in alternative aspects, without using artificial intelligence.

Moreover, although the methods described elsewhere herein may not directly mention ML techniques, such methods may be read to include such ML for any determination or processing of data that may be accomplished using such techniques. In some aspects, such ML techniques may be implemented automatically upon occurrence of certain events or upon certain conditions being met. In any event, use of ML techniques, as described herein, may begin with training a ML program, or such techniques may begin with a previously trained ML program.

In any event, the memory 106 may also include a copy of a distributed ledger 106b. Namely, the memory 106 may store a copy of a distributed ledger 106b that is distributed and/or otherwise stored on various other computing systems (e.g., other nodes). The copy of the distributed ledger 106b stored in the memory 106 may include transaction records corresponding to multiple different users and multiple different assets. For example, the distributed ledger 106b may include transaction records corresponding to a first user selling a first asset (e.g., a piece of artwork), buying a second asset (e.g., opening an investment account), and paying to invest more funds in the second asset. Similarly, the distributed ledger 106b may include transaction records corresponding to a second user buying a third asset (e.g., a life insurance policy) and later increasing coverage limits of the third asset. The distributed ledger 106b may further include transaction records corresponding to newly minted digital assets (e.g., NFTs) and/or updated digital assets associated with updates to and/or otherwise associated with the assets and/or representing a product or service associated with an asset.

Therefore, as the memory 106 stores a copy of the distributed ledger 106b, the computing system 100 may contribute and/or otherwise participate in updating and/or validating additional entries or changes to the distributed ledger 106b by achieving consensus with the other nodes (not shown) that include a copy of the distributed ledger 106b. Further, the distributed ledger 106b may also include the consensus rules and/or other instructions required for the computing system 100 to perform the calculations necessary to validate new additions and/or changes to entries in the ledger 106b. The computing system 100 may communicate with the other connected nodes that participate in the validation/consensus process for the distributed ledger 106b through the networking interface 108.

In particular, the computing system 100 includes a networking interface 108 to connect with external devices, such as the additional nodes that contribute and/or otherwise participate in the updating/changing of entries in the distributed ledger 106b through the consensus process. More specifically, the networking interface 108 may enable the computing system 100 to communicate with other computing systems (e.g., additional nodes) across a network through their respective networking interfaces 108. The networking interface 108 may support wired or wireless communications, such as USB, Bluetooth, Wi-Fi Direct, Near Field Communication (NFC), etc. The networking interface 108 may allow the computing system 100 to communicate with other computing systems via a wireless communication network such as a fifth-, fourth-, or third-generation cellular network (5G, 4G, or 3G, respectively), a Wi-Fi network (802.11 standards), a WiMAX network, a wide area network (WAN), a local area network (LAN), etc.

The computing system 100 may also provide a display 110, an input device 114, and/or other I/O components (e.g., ports, capacitive or resistive touch sensitive input panels, keys, buttons, lights, LEDs), which may be directly accessible via or attached to the computing system 100 or may be indirectly accessible. According to some embodiments, a user may access the computing system 100 via the input device 114 to review information, make changes, input training data or images, and/or perform other functions.

For example, and to provide for interaction with an individual, the herein disclosed embodiments may be implemented using the display 110, such as a user interface. Such user interfaces may include interactive features such as pop-up or pull-down menus, lists, selection tabs, checkboxes, radio buttons, toggles, sliders, buttons, hyperlinks and/or other features or user interface widgets that can receive human inputs. The display 110 may also include one or more of a number of output mechanisms, such as a display screen, a printer, a speaker, a heads-up display, an augmented reality display, a virtual reality headset, or any other output or display mechanism.

Further, to enable human (and in some instances, machine) user interaction, the computing system 100 may include an input device 114. The input device 114 may be or include, for example, a microphone for speech and audio, a touch sensitive screen for gesture or graphical input, keyboard, mouse, motion input, motion detection, camera for video and photo input, virtual reality gloves, controllers, thumb rings, wands, move controllers, touch controllers, knuckle controllers, glasses with eye controllers, and the like. In some instances, multimodal input devices 114 may enable a user to provide multiple types of input to communicate with the computing system 100.

In certain embodiments, the computing system 100 may also include clients and servers, in a host server configuration. A client and server may generally be remote from each other, and may typically interact through a communications network. The relationship of client and server arises by virtue of computer programs running on the respective computers and having a client-server relationship to each other. In some examples, a server transmits data (e.g., an HTML page, data tagged by XML, JSON objects, etc.) to a client device (e.g., for purposes of displaying data to and receiving input from a user interacting with the client device). Data generated at the client device (e.g., as a result of user interaction) can be received from the client device at the server.

More specifically, the computing system 100 may act as a hosting server, and may include a networking interface 108 configured to communicate (e.g., send and receive) data via one or more external/network port(s) to one or more networks or local terminals, as described herein. In some embodiments, the computing system 100 may include a client-server platform technology such as ASP.NET, Java J2EE, Ruby on Rails, Node.js, a web service or online API, responsive for receiving and responding to electronic requests. The computing system 100 may implement the client-server platform technology that may interact, via a computer bus, with the memory 106 (including the applications(s), component(s), API(s), data, etc. stored therein) and/or external storage device 112 to implement or perform the machine readable instructions, methods, processes, elements or limitations, as illustrated, depicted, or described for the various flowcharts, illustrations, diagrams, figures, and/or other disclosure herein. According to some embodiments, the computing system 100 may include, or interact with, one or more transceivers (e.g., WWAN, WLAN, and/or WPAN transceivers) functioning in accordance with IEEE standards, 3GPP standards, or other standards, and that may be used in receipt and transmission of data via external/network ports connected to a computer network. In some embodiments, the computer network may comprise a private network or local area network (LAN). Additionally, or alternatively, the computer network may comprise a public network such as the Internet.

FIG. 2A depicts an exemplary distributed ledger system 200 for recording asset information. The distributed ledger system 200 includes a distributed ledger 210 and a plurality of nodes 202, 204, 206, and 208. Each node 202-208 may maintain a copy of the distributed ledger 210. As illustrated, N may be any integer value, such that there may be any suitable number of nodes 202-208 that maintain a copy of the distributed ledger 210. The N number of nodes 202-208 may also each be included as part of the consensus mechanism/method used to update/change the distributed ledger 210.

As previously mentioned, as changes are made to the distributed ledger 210, each node 202-208 receives the change via the network 201 and updates its respective copy of the distributed ledger 210. A consensus mechanism may be used by the nodes 202-208 in the distributed ledger system 200 to decide whether it is appropriate to make received changes to the distributed ledger 210. For example, the consensus mechanism may be the Stellar Consensus Protocol (SCP), a variant of Practical Byzantine Fault Tolerance (PBFT), where nodes 202-208 belonging to intersecting groups run a local consensus protocol among their members, providing a method that is decentralized and open to the public. As a result of this consensus method, every intersecting group may participate in the consensus protocol with very low transaction latency. Of course, it should be understood that any suitable consensus mechanism/method or combinations thereof may be used.

Therefore, by maintaining a consensus among the nodes 202-208 to authorize any/all updates/changes to the distributed ledger 210, each node 202-208 in the distributed ledger system 200 may have an identical copy of the distributed ledger 210 to every other copy of the distributed ledger 210 stored by the other nodes 202-208. Accordingly, the distributed ledger system 200 may be more robust than a central authority database system because of the decentralized nature of the distributed ledger 210, such that there is no single point of failure in the distributed ledger system 200 as there is in conventional centralized systems.

To illustrate, node A 202 may receive information/data from a user or other entity indicative of an action (e.g., sale, maintenance, active/inactive insurance policy, etc.) or update corresponding to an asset (e.g., insurance policy) that includes data corresponding to the user/entity. For example, node A 202 may receive the information/data from a platform application (e.g., platform application 106a) executing on a user computing device, the information/data may comprise an update, and the update may include (i) an association indication between the user of the user computing device and a second entity (e.g., insurance provider) and (ii) an achievement of the user. The node A 202 may then generate a transaction based upon the update, and the transaction may include a digital asset (e.g., NFT) associated with the update. Accordingly, the node A 202 may record the transaction in the distributed ledger 210, and responsive to recording the transaction in the distributed ledger 210, the node A 202 may transmit a notification to the user computing device indicating the digital asset associated with the update.

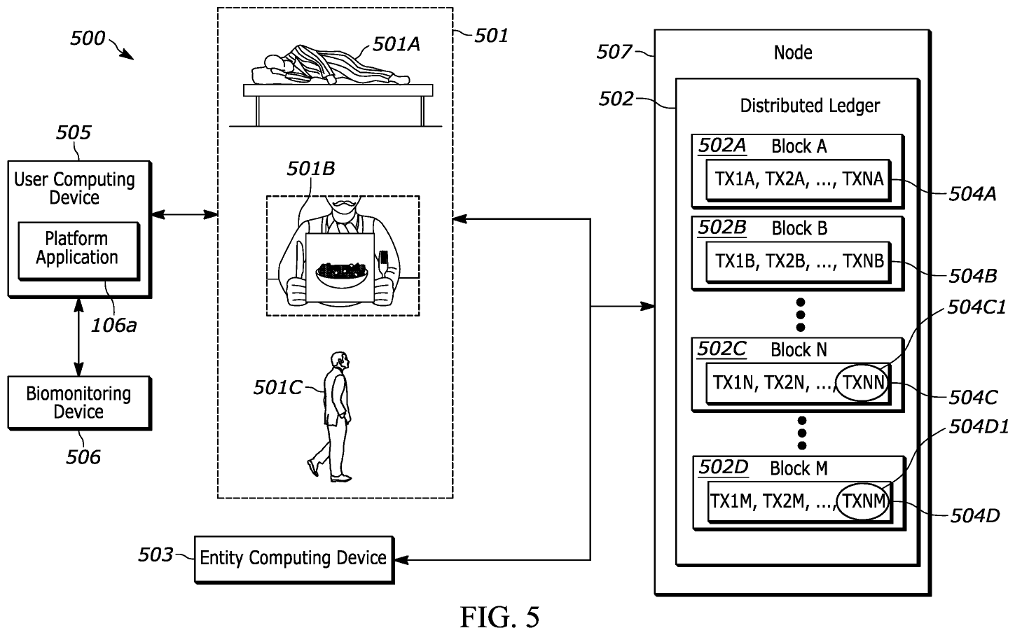

The digital asset may generally be an NFT minted on the distributed ledger 210, and the NFT may include and/or otherwise reference of a digital image, a digital audio file, an animated image, and/or any other suitable representation or combinations thereof. Further, the NFT may be associated with updates recorded in the distributed ledger 210, such that achievements accomplished by a user may be reflected and/or otherwise represented by the NFT. Therefore, and as discussed in reference to FIG. 5, a user transmitting updates for recordation in the distributed ledger 210 may also receive/view the NFT (e.g., represented by the digital image, digital audio file, animated image, etc.), as a result of the NFT being minted/updated in the distributed ledger 210 and subsequently transmitted in a notification to the user.

In any event, node A 202 may generate a transaction representing and/or otherwise based upon the update, and may tentatively upload the transaction to the distributed ledger 210. This uploaded transaction may be transmitted to each of the connected nodes 204-208, where each connected node 204-208 independently performs the calculations necessary to validate the authenticity of the transaction for recordation in the distributed ledger 210. Upon reaching a consensus among all nodes 202-208, the transaction corresponding to the update may be officially recorded in the distributed ledger 210 and represented in all copies of the distributed ledger 210 in all connected nodes 202-208.

To provide a clearer understanding of the functionality of each node 202-208 in the distributed ledger system 200, FIG. 2B depicts exemplary components of a validating network node 220 on a distributed ledger system (e.g., distributed ledger system 200) for recording asset information. Generally speaking, the validating network node 220 may be or include components of the computing system 100 illustrated in FIG. 1. The validating network node 220 may include at least one processor 224, a memory 226, blockchain data 226a, smart contracts 226b, a communication module 228, a set of external ports 230, and a blockchain manager 232. Of course, the validating network node 220 may have additional or fewer components than described.

The validating network node 220 may generate a new block of transactions, and/or may broadcast transactions to other network nodes by using the blockchain manager 232. The blockchain data 226a stored in the memory 226 may be or include a state database of the distributed ledger (e.g., distributed ledger 106b, 210) for storing states of smart contracts deployed thereon, such that the blockchain manager 232 may reference the blockchain data 226a when broadcasting transactions to other network nodes. Similarly, the validating network node 220 may use the blockchain manager 232 in conjunction with the processor 224 and the smart contracts 226b stored in the memory 226 to execute some of the functionality disclosed herein related to generating and/or executing transactions for recordation in the distributed ledger.

In certain embodiments, the smart contracts 226b may operate independent of the blockchain manager 232 and/or other applications. For example, the smart contracts 226b may automatically execute in response to the satisfaction of a triggering condition (e.g., payment receipt), such that the processor 224 does not access and/or otherwise interact with the blockchain manager 232 when the triggering condition for the smart contract 226b is received and/or otherwise satisfied. In some embodiments, the validating network node 220 may not have a blockchain manager 232 or smart contracts 226b stored at the node 220, and these components may be stored in an external database/server or other connected nodes (e.g., external storage device 112, external computing device 116).

### Exemplary Transaction Recordation in a Distributed Ledger

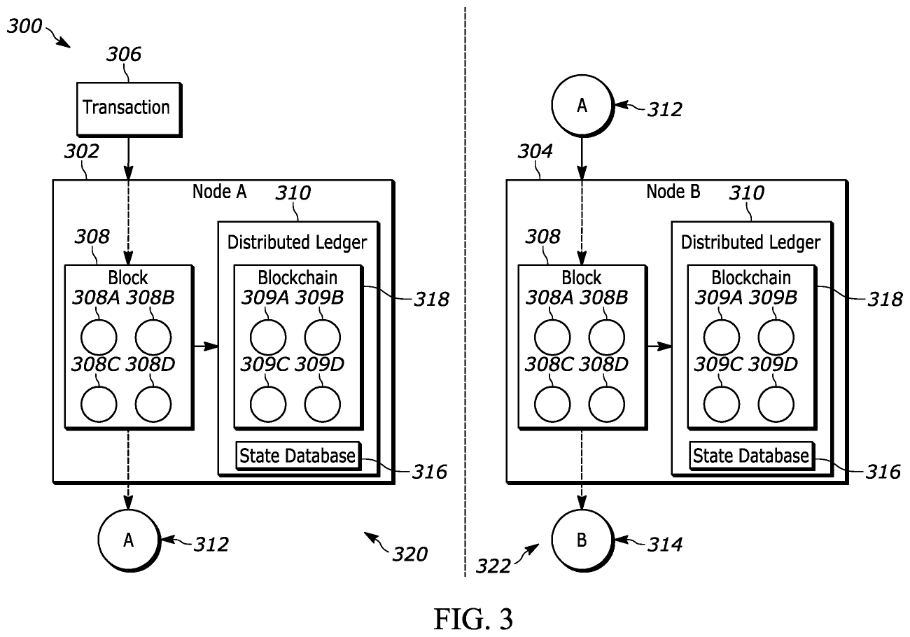

As mentioned, each node of a distributed ledger network/system may be involved in the consensus mechanism required to record transactions in the distributed ledger. To illustrate this concept, FIG. 3 depicts exemplary validating network nodes 302 and 304 and an exemplary transaction flow 300 on a distributed ledger network for resolving transactions. FIG. 3 includes two time frames 320 and 322 represented by the left and right sides of the dotted line, respectively, node A 302 and node B 304 (which may be part of the same distributed ledger network), a set of transactions 308A-308D, a set of transaction blocks 309A-309D, a distributed ledger 310, and a blockchain 318 within the distributed ledger 310.

The transaction flow 300 may begin with node A 302 receiving transaction 306 at time 320. For example, the transaction 306 may represent a vehicle sale, a vehicle obtaining insurance, and/or any other suitable action generally corresponding to the vehicle. When node A 302 confirms that transaction 306 is valid, node A 302 may add the transaction 306 to a newly generated block 308. As part of adding the transaction 306 to block 308, node A 302 may solve a cryptographic puzzle and include the solution in the newly generated block 308 as proof of the work done to generate the block 308. Alternatively, a proof of stake algorithm may be used to generate the block 308, whereby node A 302 “stakes” an amount of a digital token used on the network. In another embodiment, a proof of authority (PoA) algorithm may be used to generate the block 308, where transactions and blocks are validated by approved accounts, known as validators which run software allowing them to record transactions in the distributed ledger 310.

In other embodiments, the transaction 306 may be added to a pool of transactions until a sufficient number of transactions in the pool exist to form a block or distributed ledger entry. Node A 302 may transmit the newly created distributed ledger entry 308 to the network at time 312. Before or after propagating the newly generated block 308, node A 302 may add the newly generated block 308 to its copy of the distributed ledger 310.

While proof of work, proof of stake, and/or proof of authority are described herein as consensus algorithms for selecting a node to mint a new distributed ledger entry (e.g., newly generated block 308), these are merely a few example consensus algorithms and are not intended to be limiting. Additional consensus algorithms may be utilized, such as delegated proof of stake where nodes elect a subset of nodes referred to as delegates to perform validation, and the delegates take turns minting new distributed ledger entries. Consensus algorithms may also include proof of weight, Byzantine fault tolerance, such as practical and federated Byzantine fault tolerance, tangle consensus algorithms, block lattice consensus algorithms, etc. Additionally, quorum slices may be selected where a quorum is a set of nodes that participate in the consensus protocol and a quorum slice is its subset that helps a node in its agreement process. Individual trust decisions may be made by participants in the distributed ledger network to construct a quorum slice. Still further, security circles may be identified which are closed groups of network participants who together can form a quorum to reach a consensus on a transaction and to make further trust decisions.

In any event, the set of transaction blocks 309A-309D may include updates to a state database 316. The state database 316 may contain current values of variables created by smart contracts deployed on the distributed ledger 310. Validated distributed ledger entries, such as the newly generated block 308, may include transactions effecting state variables in state database 316.

At time 322, Node B 304 may receive the newly generated block 308 via the network at 312. Node B 304 may verify that the newly generated block 308 is valid by checking the solution to the cryptographic puzzle provided in the newly generated block 308. If the solution is accurate, then Node B 304 may add the newly generated block 308 to its distributed ledger 310 and make any updates to the state database 316 as included in the transactions of the newly generated block 308. Node B 304 may then transmit the newly generated block 308 to the rest of the network at time 314.

More specifically, the newly generated block 308 may be linked to the other transaction blocks 309A-D in the blockchain 318 through various suitable methods. For example, to cryptographically link the newly generated block 308 to the set of transaction blocks 309A-D, the nodes 302, 304 may organize the transactions (e.g., 308A-D) of each block 308, 309A-D into a Merkle Tree. In a Merkle Tree, each transaction 308A-D may be hashed according to a cryptographic hashing algorithm (e.g., SHA-256), and the resulting output hash may then be combined with the hash of another transaction. The combined result may then also be hashed according to the cryptographic hashing algorithm. The hashed combined result may then be combined with the hash of two other transactions, and this process may be repeated until all of the transactions 308A-D in the newly generated block 308 are combined and hashed to generate a Merkle root that is used in the header for the newly generated block 308. If any transaction 308A-D in the newly generated block 308 is tampered with, a different Merkle root would be generated, as the Merkle root is a combination of the hashes of all of the transactions 308A-D in the newly generated block 308.

Simply put, the transactions 308A-D may be hashed using a cryptographic hash algorithm, and the hash of each transaction 308A-D may be stored in the tree. As the tree is constructed, the hash of each adjacent node at the same level may be hashed together to create a new node that exists at a higher level in the tree. Therefore, the node at the top of the tree (i.e., the Merkle root) may be dependent upon the hash of each transaction 308A-D stored below in the tree. Each transaction 308A-D may include a set of data, such as identifying data for the transaction and transaction data identifying the nature of the transaction and what the transaction entails (e.g., input and output addresses, a transaction value, a document hash value, a timestamp, a transaction fee value, etc.).

Thereafter, to verify that a block (e.g., newly generated block 308) is valid, a node may compare the Merkle root of the block 308 to the Merkle root for the same block 308 included in other nodes' copies of the blockchain 318. Therefore, the Merkle root can be used as proof of the transactions included in the newly generated block 308, and as proof that the contents of the newly generated block 308 have not been tampered with when the Merkle root is the same in each node's copy of the newly generated block 308.

Accordingly, in some embodiments, documents stored “on” the blockchain 318 may be documents that have been hashed according to a cryptographic hashing algorithm (e.g., SHA-256), and the resulting output hash has been included in a transaction 308A-D in a block 308 that has been accepted by the network nodes 302, 304 as satisfying the consensus rules of the blockchain 318. As such, the documents may be later verified or validated by comparing the hash of the documents to the hash stored on the blockchain 318. For example, if a set of documents results in a SHA-256 hash that was recorded on the blockchain 318 on a certain date, then the blockchain 318 may provide cryptographic proof that the documents existed as of that date.

Additionally, one way the nodes 302, 304 may store a document on the blockchain 318 is by broadcasting a transaction 308A-D including a hash of the document to the network, which may be included in the newly generated block 308 if the transaction 308A-D satisfies all of the consensus rules of the network. In some embodiments, only a cryptographic hash of the data may be included in the blockchain 318, such that the data may be verified using the blockchain 318 even if it is obtained by a party off-chain.

In some embodiments, a valid proof-of-identity may be applied as a consensus rule by the nodes (e.g., node A 302, node B 304) participating in the blockchain network of the blockchain 318. As such, any transaction 308A-D attempting to add new property information without a cryptographic proof-of-identity matching an identity authorized to add new property information is rejected by the nodes 304 validating new entries to the blockchain 318 as being non-compliant with the consensus rule. Each property owner may be assigned a public key/private key pair which is identified in the blockchain network as corresponding to the owner. If the validating network nodes receive a transaction regarding property information that is not from an authorized owner, the validating network nodes may reject the transaction. In certain embodiments, the consensus rules may also include a maximum transaction size, such that transactions in the respective blockchain network may not exceed the maximum transaction size.

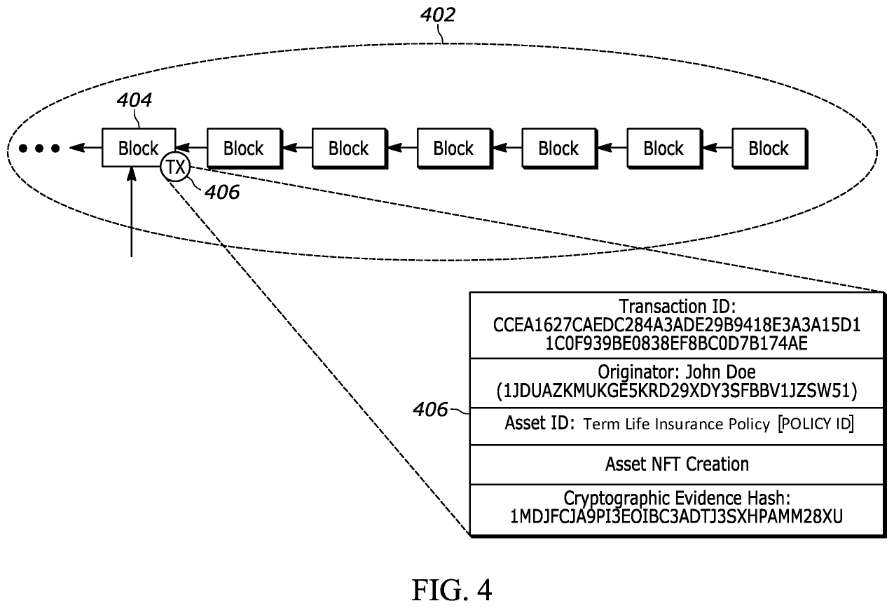

FIG. 4 illustrates an exemplary transaction 406 recording identification information for an asset, along with minting a digital asset (e.g., NFT) that is associated with the asset, in a distributed ledger 402 of the distributed ledger 310 illustrated in FIG. 3. The transaction 406 may include a transaction ID and an originator such as John Doe who may be the owner of the term life insurance policy (identified by a cryptographic proof-of-identity). The transaction 406 may also include identification information for the asset, such as an asset identification number (POLICY ID), and a description of the asset (Term Life Insurance Policy), etc. In another example where the asset is a piece of artwork, the identification information may include the name of the artist or artists, the name of the art piece, the year created, materials used, the genre (e.g., impressionist), the weight, image file(s), dimensions, etc. Of course, it should be appreciated that the transaction 406 may include and/or otherwise reference any suitable information corresponding to the asset and/or the user/entity listing the transaction.

As illustrated in FIG. 4, the transaction 406 may mint an NFT that is associated with the asset. For example, the NFT may include and/or otherwise reference properties of the asset, such as the identification information. In certain embodiments, the NFT may include a status that indicates an association between the owning entity and a second entity that corresponds to the asset. For example, the asset may be a life insurance policy or investment account, and the NFT may include a status indicating that the life insurance policy or investment account is active with a particular issuing entity (e.g., State Farm). Accordingly, the NFT may also be or include a visual representation (e.g., digital image) of a logo corresponding to the particular issuing entity, such that the visual representation may be visible in a virtual environment (e.g., Metaverse), and/or rendered on a display when a computing device verifies the status of the digital asset. In any event, the NFT may be recorded in the distributed ledger 402 and may thereby be available for reference as part of the listed transaction. In certain embodiments, an NFT representing and/or otherwise corresponding to the asset may be obtained from an external system. The transaction may then record the obtained NFT in the distributed ledger 402.

Furthermore, the transaction 406 may include a cryptographic hash of the identification information. For example, the transaction 406 illustrated in FIG. 4 includes a cryptographic evidence hash that is stored in the distributed ledger 402 as part of the transaction 406. In some embodiments, the identification information may not be stored as a cryptographic hash, but may be directly accessible in block 404 by an observer or other network participant.

To facilitate the sale of assets and/or digital assets and ensure transparency in transactions involving these assets/digital assets, the nodes (e.g., node A 302, node B 304) that participate in the validation/consensus mechanism for a distributed ledger (e.g., distributed ledger 402) may generate and display user interfaces on client devices of users. A client device may be a smart phone, a tablet, a laptop computer, a desktop computer, a wearable device such as a smart watch or smart glasses, etc. The client devices may communicate directly with a distributed ledger, such as the distributed ledger 402 as shown in FIG. 4. In other embodiments, a server device may connect to and/or otherwise monitor the distributed ledger 402, obtain transaction information from the distributed ledger 402, and may provide the transaction information to a client device for display to the user. Therefore, in certain embodiments, the client device may be a node connecting directly to the distributed ledger 402, and in other embodiments, the client device may connect to a node that is connected to the distributed ledger 402.

### Exemplary User Interfaces and Virtual Experiences

FIG. 5 illustrates exemplary digital asset minting transactions 500 in response to receiving updates from a platform application (e.g., platform application 106a) of a user computing device 505, in accordance with various embodiments herein. The exemplary digital asset minting transactions 500 may generally include a set of achievements 501 that a user may complete and/or otherwise pursue. This set of achievements 501 may be transmitted to a node storing a copy of the distributed ledger 502. One or more of the set of achievements 501 may be utilized to generate one or more transactions 504C1, 504D1, and those one or more transactions 504C1, 504D1 may be recorded on the distributed ledger 502 to mint and/or update digital assets associated with the set of achievements 501. The entity computing device 503 may also provide updates for recordation on the distributed ledger 502 that may affect the digital assets minted/updated as a result of the set of achievements 501. When the digital asset and/or representation thereof is recorded on the distributed ledger 502 (e.g., as part of transactions 504C1, 504D1), a user may receive notifications corresponding to the digital asset that may indicate minting and/or updates of the digital asset.

In particular, the set of achievements 501 may represent various actions/behaviors that a user may accomplish/complete and/or otherwise pursue that may result in discounts, real-world currency, virtual currency, and/or other benefits based upon an association between the user and a second entity. These associations between the user and a second entity may generally include an insurance policy, an investment account, and/or any other suitable association between a user and a second entity (e.g., an insurance provider, an investment account broker, etc.).

Generally, the set of achievements 501 may include a sleep value 501A, an eating value 501B, an exercise value 501C, a driving value, a total investment value, a policy length value, and/or any other suitable values corresponding to any suitable assets or combinations thereof. For example, the sleep value 501A may represent an achievement that corresponds to a user's life insurance policy because the user achieving a healthy level of sleep over a sustained period of time (e.g., one year) may indicate healthy behavior that may extend the user's life expectancy. As another example, a policy length value may represent an achievement that corresponds to a user's real property insurance policy because maintaining an active real property insurance policy over a sustained period of time (e.g., ten years) may indicate responsible behavior in maintaining the user's real property.

Each of the achievements in the set of achievements 501 may have different threshold values that a user may need to satisfy to receive benefits from the achievements. For example, the eating value 501B may require a user to satisfy certain daily nutritional requirements over a first period (e.g., one month, three months, six months, one year, etc.), and the exercise value 501C may require the user to satisfy certain biomarker requirements (e.g., elevated heart rate, step count, etc.) over a second period (e.g., one week, two weeks, one month, etc.). Of course, the threshold values and/or periods over which a user must satisfy certain requirements to perform a corresponding achievement may be identical for some achievements, but these threshold values and/or periods may generally be different for each achievement.

In response to the user performing one or more of these achievements, the user may receive various benefits. These benefits may include, for example, a discount corresponding to an association indicated by an association indication between the first entity and the second entity, a real-world currency value, a virtual currency value, a discount corresponding to a third entity, and/or any other suitable benefit or combinations thereof. For example, the discount provided to the user as a result of an achievement may include a discounted premium payment on one or more future premium payments on an insurance policy. Additionally, or alternatively, the user may receive a discount coupon for goods/services at a third entity (e.g., vehicle maintenance provider, contractor services, etc.) that may be associated with the asset (e.g., vehicle, real property) corresponding to the insurance policy (e.g., vehicle insurance policy, real property insurance policy) or other association between the user and the second entity.

Accordingly, a user computing device 505 may track user activities corresponding to the set of achievements through various sensors (not shown) connected to the user computing device 505. Additionally, or alternatively, the user computing device 505 may be connected to an additional device, such as a biomonitoring device 506 (e.g., smartwatch), that may record data corresponding to the set of achievements for processing at the user computing device. In particular, the user computing device 505 and/or the biomonitoring device 506 may record heart rate data, sleep data, nutritional intake data, blood-oxygen level data, steps taken data, and/or any other suitable biomarker data. As a result, the user computing device 505 may determine when a user has accomplished any of the set of achievements 501, and therefore has earned a benefit.

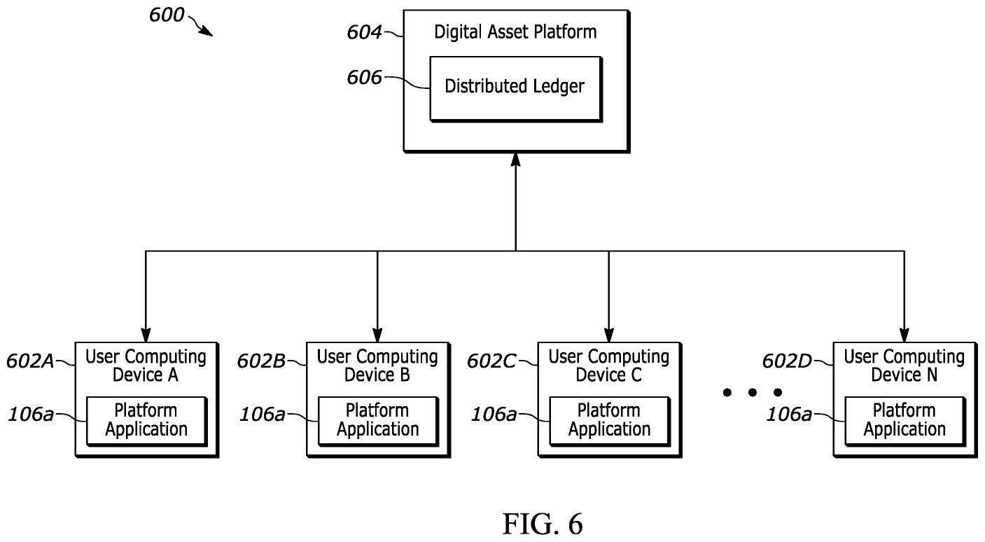

In response to determining that the user has accomplished any of the set of achievements 501, the user computing device 505 may transmit an update to the node 507 that includes association indication between the user of the user computing device 505 and a second entity (e.g., insurance provider, etc.) and an achievement of the user to a node 507 that maintains a copy of the distributed ledger 502. The node 507 may then generate the transaction 504C1 based on a transaction listing that includes, for example, a digital asset associated with the update transmitted by the user computing device 505 (e.g., through the platform application 106a). The node may mint the digital asset by successfully recording the transaction 504C1 in the distributed ledger 502. Accordingly, the node 507 may transmit a notification back to the user computing device 505 indicating the digital asset associated with the update. Moreover, the digital asset may have an associated value, which may change over time, and as discussed herein in reference to FIG. 6.

As part of the notification, the node 507 may include the digital asset and/or a representation of the digital asset for display to the user of the user computing device 505. Generally speaking, the digital asset (e.g., NFT) included in the notification and/or otherwise presented to a user or on a digital asset platform may be and/or be represented as a digital image, a sound file with which a user may interact (e.g., click, tap, swipe, verbal command, etc.) to receive the corresponding sound, and animated image that may include animations or other series/sequences of images, or the like. For example, the digital asset may be or be represented as a logo of an insurance provider (e.g., State Farm) that provides a user's life insurance policy, real property insurance policy, vehicle insurance policy, valuable personal property insurance policy, and/or any other suitable policy or combinations thereof. In certain instances, the display of the digital asset may include a status indication of the digital asset. For example, the status indication may correspond to whether or not an insurance policy issued by the insurance provider is currently active for the user.

In some embodiments, an entity computing device 503 (e.g., an insurance provider device) may generate and transmit a subsequent update to the node 507 for recordation in the distributed ledger 502, for example, to update the status of the digital asset associated with the achievements transmitted from the user computing device 505. For example, the entity computing device 503 may transmit a subsequent update related to the digital asset to the node 507 for recordation in the distributed ledger 502. The subsequent update may generally include an updated association indication between the user and the second entity (e.g., an insurance provider). When the entity computing device 503 transmits the subsequent update to the node 507, the node 507 may generate and record a transaction 504D1 based upon the updated association indication.

Accordingly, the node 507 may record the transaction 504D1 in the distributed ledger 502, and may thereby update a status of the digital asset minted/updated by transaction 504C1. For example, the updated association indication may indicate that the user no longer has an active life insurance policy with the insurance provider, such that the status of the digital asset corresponding to the life insurance policy may change. As discussed further herein in reference to FIG. 6, the status of the digital asset corresponding to the life insurance policy may change from “ACTIVE” to “INACTIVE”, and as a result, redemption options for the digital asset may also change.

In any event, the node 507 may generate the transaction 504D1 based on a subsequent transaction listing that includes, for example, the subsequent update related to the digital asset minted/updated by transaction 504C1. The node 507 may record the transaction 504D1 in the distributed ledger 502, and may then transmit a subsequent notification back to the user computing device 505 indicating the subsequent update related to the digital asset. It should be understood that N and M may be any integers, such that the distributed ledger 502 may include any suitable number of blocks 502A-D, and each block 502A-D may include any suitable number of transactions 504A-D, 504C1, 504D1.

Therefore, in some embodiments, the node 507 and/or other suitable device may change the status of a digital asset minted/updated in the distributed ledger 502 to reflect the subsequent update included in the transaction 504D1. Further, the node 507 and/or other suitable device and may change an appearance of the digital asset to reflect the subsequent update when the updated digital asset is displayed and/or otherwise represented for a user (e.g., as part of a notification). For example, the node 507 and/or any other suitable device may alter the digital image, sound file, animated image, and/or other suitable displayed qualities of the digital asset in response to the subsequent update included in the transaction 504D1. The alterations may be or include a greying out of a logo representative of an insurance provider, an inability to play the audio recording, no animation sequence playing upon viewing of the animated image, and/or any other suitable alteration to the appearance of the digital asset when viewed and/or otherwise displayed to a user as part of a notification and/or within a digital asset platform, as described herein.

### Exemplary Digital Asset Platform

As previously mentioned, the systems and methods of the present disclosure enable minting digital assets in response to user achievements and allowing the users to access a digital asset platform to interact with other users by selling, buying, auctioning, and/or otherwise transacting with the digital assets. Once on the digital asset platform, the user may sell or auction the digital asset to other entities/users that are connected to the digital asset platform (e.g., via a platform application 106a). In certain embodiments, an entity/user that manages and/or otherwise has administrative permissions regarding the digital asset platform may mint digital assets on the distributed ledger and post the digital assets directly to the digital asset platform for auction/sale by other entities/users.

In particular, FIG. 6 depicts a digital asset platform 604 communicating with multiple user computing devices 602A-602D executing a platform application 106a, in accordance with various embodiments herein. Generally speaking, the digital asset platform 604 may be or include a node that maintains a copy of the distributed ledger 606, and the digital asset platform 604 may also host a marketplace/platform for connected users/entities to buy, sell, auction, redeem, and/or otherwise transact or trade digital assets (e.g., NFTs). In certain embodiments, the digital asset platform 604 may be a server that is maintained by a hosting entity (e.g., insurance provider, vehicle manufacturer, etc.), and the digital asset platform 604 may host the marketplace/platform as well as serving as a location where digital assets for the hosting entity and/or other users/entities may be minted for sale, auction, trade, redemption, and/or otherwise distribution to connected users/entities.

Of course, while referenced herein as primarily applying to insurance policies and/or investment account, it should be appreciated that such digital asset minting, buying, selling, auctioning, and/or otherwise distributing on the digital asset platform 604 may apply to any suitable underlying asset, such as vehicles, real property, personal property, and/or any other suitable assets or combinations thereof. Moreover, it should be understood that N may be any integer, such that any suitable number of user computing devices 602A-D may connect and/or otherwise interact with the digital asset platform 604.

Digital assets included in the distributed ledger 606 of the digital asset platform 604 may each have an associated value. Connected users (e.g., via user computing devices 602A-D) to the digital asset platform 604 may receive indications of the associated values for respective digital assets when they access the digital asset platform 604. Users/entities accessing the digital asset platform 604 through the connected user computing devices 602A-D may thereby auction, buy, sell, redeem, and/or otherwise exchange digital assets included in the distributed ledger 606 based upon these associated values. The sale, purchase, redemption, etc. of such digital assets on the digital asset platform 604 may be performed using real currency, virtual currency, discounts, and/or other incentives or combinations thereof. Moreover, the values associated with each digital asset may change over time based upon, for example, value changes in underlying assets, prior sale values, and/or due to any other suitable forces or combinations thereof.

As mentioned, the hosting entity may mint digital assets on the digital asset platform to sell, auction, trade, redeem, and/or otherwise distribute the digital assets to connected users/entities. As part of this minting, the hosting entity may also structure assets in a manner that links the value of a minted digital asset to the underlying value of the asset. For example, the hosting entity may structure investment accounts, insurance accounts, and/or other assets in a manner that links a digital asset to the asset when a transaction corresponding to the asset is recorded in the distributed ledger 606. In this manner, connected users who purchase these assets may receive the digital assets through the digital asset platform 604 that have values tied to the underlying value of the asset. The digital asset value may correspond to the underlying asset value by, for example, a user's investment account balance in an investment account issued by the hosting entity, a total insurance benefit from a policy issued by the hosting entity, and/or any other valuation for an asset issued by the hosting entity and/or other entities utilizing the digital asset platform.

As an example, the digital asset platform 604 may receive a subsequent update from a platform application 106a on a user computing device (e.g., user computing device A 602A) that corresponds to a prior achievement of a user of the user computing device A 602A. The subsequent update may include at least one of: (1) a subsequent association indication between the user and the second entity (e.g., hosting entity), or (2) a subsequent achievement of the user. The subsequent association indication between the user and the second entity may indicate, for example, that the user has recently closed an investment account issued by the hosting entity. The subsequent achievement may indicate, for example, that the user input their first $1,000 into the investment account.

Regardless, as a result of the digital asset platform 604 receiving the subsequent update, the digital asset platform 604 may update at least one of: (i) a total value of the digital asset associated with the asset, (ii) a periodic value for the digital asset, or (iii) an appearance of the digital asset. The total value of the digital asset may be the total sale value or estimated auction value of the asset, and the total value may increase as a result of the user inputting additional funds into the investment account. The periodic value of the digital asset may be or correspond to periodic price adjustments or other benefits acquired corresponding to the underlying asset through ownership of the digital asset, such as periodic/recurring premium reductions of an insurance policy. Updating the appearance of the digital asset may be or include altering the digital image, sound file, animated image, and/or other suitable displayed qualities of the digital asset in response to the subsequent update.

In certain embodiments, users may purchase digital assets through the digital asset platform 604 as an alternative form of investment in an underlying asset purchased and/or otherwise acquired from the hosting entity and/or other entities utilizing the digital asset platform 604. As time passes, the value of the underlying asset (e.g., insurance policy, investment account, vehicle, etc.) may increase/decrease, and the value of the digital asset may also vary. Purchasing the digital asset in tandem with the underlying asset may provide a user with a more diversified position by allocating funds between the asset and the digital asset, and as such, the hosting entity may offer discounted rates for the purchase of the underlying asset that is compensated for by the purchase of the accompanying digital asset.

As an example, a user of user computing device B 602B may purchase a digital asset from the digital asset platform 604 when the user opens an investment account with the hosting entity. In this example, the customer may hold the digital asset for as long as the user has the corresponding investment account. As the user invests additional funds and the investment account matures (e.g., appreciates/depreciates in value), the value of the digital asset may also increase/decrease, and the increase/decrease in value may not necessarily be related to the maturation of the investment account. For example, the digital asset may vary in value based upon the value of similar or identical digital assets that were sold on the digital asset platform 604. Therefore, the value of the digital asset and the underlying asset may change over time, and the respective changes in value may differ based on a variety of different factors.

Additionally, and as previously mentioned, the user may be rewarded and/or aspects of the digital asset may change over time based upon the user maintaining the underlying asset (e.g., active insurance policy, investment account balance is non-zero). In general, these rewards and/or changes to the digital asset may also be verified based upon the transactions associated with the digital asset that are recorded in the distributed ledger 606. For example, the user may actively maintain an insurance policy with the hosting entity for a certain threshold duration of time (e.g., five years, ten years), the digital asset platform 604 may verify that the user has reached the threshold period based upon a recorded transaction in the distributed ledger 606 that minted the corresponding digital asset at the corresponding time, and the digital asset platform 604 may reward the user by offering reduced premiums for several months.

As another example, the digital asset representation may change based upon the investment/length of time the underlying asset is maintained by the user. For example, the digital asset platform 604 may verify that the user has maintained an investment account with the hosting entity for a threshold duration, and the digital asset platform 604 may alter the digital image, sound file, animated image, and/or other suitable displayed qualities of the digital asset to reflect the user's achievement. When the digital asset platform 604 verifies that the threshold duration has been achieved for the user's investment account, the digital asset platform 604 may also authorize increased, additional, and/or otherwise different rewards provided as a result of the user owning the digital asset. For example, if a user invests a substantial amount into an investment account tied to a particular digital asset, then the digital asset may be structured to offer rewards to the user (e.g., policy discounts, real currency, virtual currency, additional digital asset investment buying power, etc.) that are more frequent and/or have a greater magnitude than rewards offered by a smaller investment into the account.

Further, the hosting entity may mint custom digital assets that are collectible and/or are otherwise limited for initial sale, auction, trading, etc. on the digital asset platform. For example, the hosting entity may mint digital assets on the digital asset platform 604, and any or all of these digital assets may be redeemable on the digital asset platform for discounts on goods/services provided by the hosting entity and/or other participating entities on the digital asset platform 604, and/or the digital assets may be raffled to random connected users and thereafter available for sale, auction, or direct purchase on the digital asset platform 604. For example, the hosting entity may engage in with celebrities, other entities, other users, and/or any other suitable participant(s) to mint unique digital assets that are associated with the celebrity/entity/user and held solely by the hosting entity. These digital assets may then be distributed to connected users in any suitable fashion, such as rewards for long-standing asset holders and/or randomly through a raffle. Thereafter, the hosting entity may provide these connected users with an option for the hosting entity to hold the digital asset on the digital asset platform 604 and/or to release the digital asset to the connected users. In this manner, the chosen connected users may also authorize the hosting entity to sell, auction, redeem, and/or otherwise transact with the digital asset on behalf of the user, or the user may choose to transact with the digital asset independently.

In certain embodiments, the hosting entity may enable users to redeem digital assets against the value and/or guarantees of the underlying asset. For example, the user may maintain an insurance policy, and the user may receive a payout from the insurance policy. In this example, the hosting entity may offer the user an option to receive the insurance payout in the form of a digital asset minted through the digital asset platform 604. The user may accept the alternative form of payment through the digital asset, and the digital asset platform 604 may then mint the corresponding digital asset, and the digital asset may initially have a value on the digital asset platform 604 corresponding to the insurance payout. The value of the digital asset may then change over time, and the user may sell the digital asset back to the digital asset platform 604 for the current market value of the digital asset and/or may auction the digital asset on the digital asset platform 604 to allow connected users to bid for the digital asset. If the digital asset has appreciated in value, the user may sell/auction the digital asset on the digital asset platform 604 to receive more than the insurance payout. In this manner, the digital asset platform 604 may offer users an alternative form of payment for underlying assets, where the user may choose to receive a digital asset in the hope that the digital asset may increase in value over time.

Exemplary Method for Digital Assets Associated with User Achievements

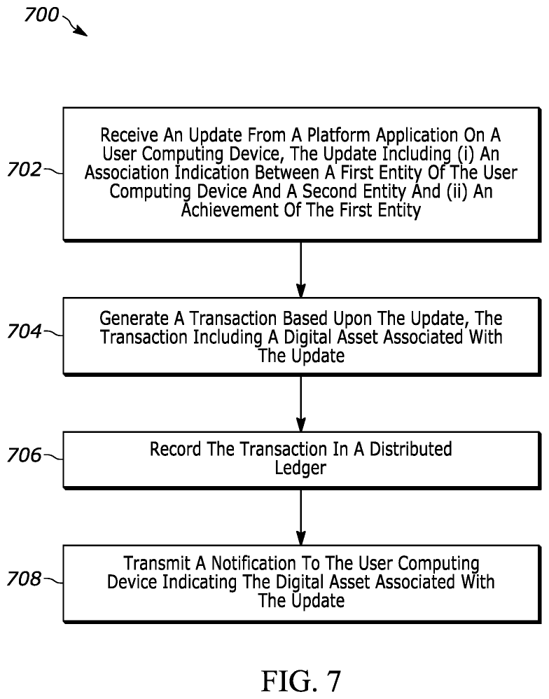

FIG. 7 is a block diagram of an exemplary computer-implemented method 700 for minting digital assets associated with user achievements in a distributed network, in accordance with various embodiments herein. Generally speaking, any of the actions described herein in reference to the exemplary method 700 may be performed by a node (e.g., nodes 202-208, 302, 304, 604), a server device (e.g., digital asset platform 604), a user computing device (e.g., user computing device 602), and/or any combinations thereof.

The method 700 may include receiving an update from a platform application (e.g., platform application 106a) on a user computing device (e.g., user computing device 602A-D) (block 702). The update may include (i) an association indication between a first entity of the user computing device and a second entity and/or (ii) an achievement of the first entity. In some embodiments, the achievement may include at least one of: (i) an exercise value, (ii) an eating value, (iii) a sleep value, (iv) a driving value, (v) a total investment value, or (vi) a policy length value.

The method 700 may further include generating a transaction based upon the update (block 704). The transaction may include a digital asset associated with the update. In some embodiments, the digital asset is a NFT minted on the distributed ledger, and the NFT may include at least one of: (i) a digital image, (ii) a digital audio file, or (iii) an animated image.

The method 700 may further include recording the transaction in a distributed ledger (block 706). In certain embodiments, the method 700 may further include recording the transaction in the distributed ledger by: recording the transaction in the distributed ledger as part of a batch recordation of a plurality of transactions that are sequentially recorded in the distributed ledger to mint a plurality of digital assets.

The method 700 may further include, responsive to recording the transaction in the distributed ledger, transmitting a notification to the user computing device indicating the digital asset associated with the update (block 708). In some embodiments, the method 700 may further include generating the notification to the user, wherein the notification includes an offer to post the digital asset on a digital asset platform. In these embodiments, the method 700 may further include receiving an acceptance indication of the offer through the platform application on the user computing device; and posting the digital asset on the digital asset platform for redemption by a third entity.

In certain embodiments, the method 700 may further include receiving a subsequent update from the platform application on the user computing device. The subsequent update may include at least one of: (1) a subsequent association indication between the first entity and the second entity or (2) a subsequent achievement of the first entity. In these embodiments, the method 700 may further include updating at least one of: (i) a total value of the digital asset, (ii) a periodic value for the digital asset, or (iii) an appearance of the digital asset in response to receiving the subsequent update.

In some embodiments, the method 700 may further include receiving a redemption request from the platform application on the user computing device. The redemption request may correspond to the digital asset. In these embodiments, the method 700 may further include transmitting a set of redemption options to the platform application on the user computing device that includes at least one of: (i) a discount corresponding to an association indicated by the association indication between the first entity and the second entity, (ii) a real-world currency value, (iii) a virtual currency value, and/or (iv) a discount corresponding to a third entity.

### Additional Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The systems and methods described herein are directed to an improvement to computer functionality, and improve the functioning of conventional computers. Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules include a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

It should also be understood that, unless a term is expressly defined in this patent using the sentence “As used herein, the term ‘_’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still cooperate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

This detailed description is to be construed as examples and does not describe every possible embodiment, as describing every possible embodiment would be impractical, if not impossible. One could implement numerous alternate embodiments, using either current technology or technology developed after the filing date of this application.

Upon reading this disclosure, those of skill in the art will appreciate still additional alternative structural and functional designs for evaluation properties, through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed:

1. A computer system for minting digital assets associated with user achievements in a distributed network, the computer system comprising:
one or more processors; and
a non-transitory computer-readable medium coupled to the one or more processors and storing instructions thereon, that when executed by the one or more processors, causes the one or more processors to:
receive an update from a platform application on a user computing device, the update including (i) an association indication between a first entity of the user computing device and a second entity and (ii) an achievement of the first entity,
generate a transaction based upon the update, the transaction including a digital asset associated with the update,
record the transaction in a distributed ledger, and
responsive to recording the transaction in the distributed ledger, transmit a notification to the user computing device indicating the digital asset associated with the update.

2. The computer system of claim 1, wherein the instructions, when executed, further cause the one or more processors to:
generate the notification to the user, wherein the notification includes an offer to post the digital asset on a digital asset platform;
receive an acceptance indication of the offer through the platform application on the user computing device; and
post the digital asset on the digital asset platform for redemption by a third entity.

3. The computer system of claim 1, wherein the instructions, when executed, further cause the one or more processors to:
receive a subsequent update from the platform application on the user computing device, the subsequent update including at least one of: (1) a subsequent association indication between the first entity and the second entity or (2) a subsequent achievement of the first entity; and
update at least one of: (i) a total value of the digital asset, (ii) a periodic value for the digital asset, or (iii) an appearance of the digital asset in response to receiving the subsequent update.

4. The computer system of claim 1, wherein the achievement includes at least one of: (i) an exercise value, (ii) an eating value, (iii) a sleep value, (iv) a driving value, (v) a total investment value, or (vi) a policy length value.

5. The computer system of claim 1, wherein the instructions, when executed, further cause the one or more processors to:
receive a redemption request from the platform application on the user computing device, the redemption request corresponding to the digital asset; and
transmit a set of redemption options to the platform application on the user computing device that includes at least one of: (i) a discount corresponding to an association indicated by the association indication between the first entity and the second entity, (ii) a real-world currency value, (iii) a virtual currency value, or (iv) a discount corresponding to a third entity.

6. The computer system of claim 1, wherein the instructions, when executed, further cause the one or more processors to record the transaction in the distributed ledger by:
recording the transaction in the distributed ledger as part of a batch recordation of a plurality of transactions that are sequentially recorded in the distributed ledger to mint a plurality of digital assets.

7. The computer system of claim 1, wherein the digital asset is a non-fungible token (NFT) minted on the distributed ledger, the NFT including at least one of: (i) a digital image, (ii) a digital audio file, or (iii) an animated image.

8. A computer-implemented method for minting digital assets associated with user achievements in a distributed network, the method comprising:
receiving, from a platform application on a user computing device, an update including (i) an association indication between a first entity of the user computing device and a second entity and (ii) an achievement of the first entity;
generating, by one or more processors, a transaction based upon the update, the transaction including a digital asset associated with the update;
recording, by the one or more processors, the transaction in a distributed ledger; and
responsive to recording the transaction in the distributed ledger, transmitting, by the one or more processors, a notification to the user computing device indicating the digital asset associated with the update.

9. The computer-implemented method of claim 8, further comprising:
generating, by the one or more processors, the notification to the user, wherein the notification includes an offer to post the digital asset on a digital asset platform;
receiving, from the platform application on the user computing device, an acceptance indication of the offer; and
posting, by the one or more processors, the digital asset on the digital asset platform for redemption by a third entity.

10. The computer-implemented method of claim 8, further comprising:
receiving, from the platform application on the user computing device, a subsequent update including at least one of: (1) a subsequent association indication between the first entity and the second entity or (2) a subsequent achievement of the first entity; and
updating, by the one or more processors, at least one of: (i) a total value of the digital asset, (ii) a periodic value for the digital asset, or (iii) an appearance of the digital asset in response to receiving the subsequent update.

11. The computer-implemented method of claim 8, wherein the achievement includes at least one of: (i) an exercise value, (ii) an eating value, (iii) a sleep value, (iv) a driving value, (v) a total investment value, or (vi) a policy length value.

12. The computer-implemented method of claim 8, further comprising:
receiving, from the platform application on the user computing device, a redemption request corresponding to the digital asset; and
transmitting, by the one or more processors, a set of redemption options to the platform application on the user computing device that includes at least one of: (i) a discount corresponding to an association indicated by the association indication between the first entity and the second entity, (ii) a real-world currency value, (iii) a virtual currency value, or (iv) a discount corresponding to a third entity.

13. The computer-implemented method of claim 8, wherein recording the transaction in the distributed ledger further comprises:
recording, by the one or more processors, the transaction in the distributed ledger as part of a batch recordation of a plurality of transactions that are sequentially recorded in the distributed ledger to mint a plurality of digital assets.

14. The computer-implemented method of claim 8, wherein the digital asset is a non-fungible token (NFT) minted on the distributed ledger, the NFT including at least one of: (i) a digital image, (ii) a digital audio file, or (iii) an animated image.

15. A tangible, non-transitory computer-readable medium storing instructions for minting digital assets associated with user achievements in a distributed network that, when executed by one or more processors of a computing device, cause the computing device to:
receive an update from a platform application on a user computing device, the update including (i) an association indication between a first entity of the user computing device and a second entity and (ii) an achievement of the first entity;
generate a transaction based upon the update, the transaction including a digital asset associated with the update;
record the transaction in a distributed ledger; and
responsive to recording the transaction in the distributed ledger, transmit a notification to the user computing device indicating the digital asset associated with the update.

16. The tangible, non-transitory computer-readable medium of claim 15, wherein the instructions, when executed, further cause the computing device to:
generate the notification to the user, wherein the notification includes an offer to post the digital asset on a digital asset platform;
receive an acceptance indication of the offer through the platform application on the user computing device; and
post the digital asset on the digital asset platform for redemption by a third entity.

17. The tangible, non-transitory computer-readable medium of claim 15, wherein the instructions, when executed, further cause the computing device to:
receive a subsequent update from the platform application on the user computing device, the subsequent update including at least one of: (1) a subsequent association indication between the first entity and the second entity or (2) a subsequent achievement of the first entity; and
update at least one of: (i) a total value of the digital asset, (ii) a periodic value for the digital asset, or (iii) an appearance of the digital asset in response to receiving the subsequent update.

18. The tangible, non-transitory computer-readable medium of claim 15, wherein the achievement includes at least one of: (i) an exercise value, (ii) an eating value, (iii) a sleep value, (iv) a driving value, (v) a total investment value, or (vi) a policy length value.

19. The tangible, non-transitory computer-readable medium of claim 15, wherein the instructions, when executed, further cause the computing device to:
receive a redemption request from the platform application on the user computing device, the redemption request corresponding to the digital asset; and
transmit a set of redemption options to the platform application on the user computing device that includes at least one of: (i) a discount corresponding to an association indicated by the association indication between the first entity and the second entity, (ii) a real-world currency value, (iii) a virtual currency value, or (iv) a discount corresponding to a third entity.

20. The tangible, non-transitory computer-readable medium of claim 15, wherein the instructions, when executed, further cause the computing device to record the transaction in the distributed ledger by:
recording the transaction in the distributed ledger as part of a batch recordation of a plurality of transactions that are sequentially recorded in the distributed ledger to mint a plurality of digital assets.
